(19) United States
(12) Patent Application Publication
(10) Pub. No.: US 2009/0123840 A1
(43) Pub. Date: May 14, 2009

(54) Non-Aqueous Electrolyte Secondary Battery

(76) Inventors: Takayuki Shirane, Osaka (JP); Katsumi Kashiwagi, Osaka (JP); Kaoru Inoue, Osaka (JP)

Correspondence Address: MCDERMOTT WILL & EMERY LLP, 600 13TH STREET, NW, WASHINGTON, DC, 20005-3096, US

(21) Appl. No.: 11/792,385

(22) PCT Filed: Dec. 14, 2006
(86) PCT No.: PCT/JP2006/324942

§ 371 Date: Jun. 6, 2007

(30) Foreign Application Priority Data
Dec. 28, 2005 (JP) 2005-377953
Oct. 2, 2006 (JP) 2006-270392

(51) Int. Cl. H01M 4/02; H01M 4/38; H01M 4/48; H01M 10/40

(52) U.S. Cl. 429/220; 429/209; 429/221; 429/223; 429/224; 429/231.5; 429/231.8; 429/218.1; 977/948

(57) ABSTRACT

A non-aqueous electrolyte secondary battery includes a negative electrode, a positive electrode, and a non-aqueous electrolyte interposed therebetween. On at least one side of a current collector of the negative electrode, is formed a negative-electrode mixture layer containing an active material capable of storing and emitting at least lithium ions. The negative-electrode mixture layer has a plurality of mixture-layer expansion-absorbing grooves formed parallel to each other in such a manner as to expose the current collector. The mixture-layer expansion-absorbing grooves are formed in the position facing the positive-electrode mixture layer.

### RELATED APPLICATIONS

This application is the U.S. National Phase under 35 U.S.C. § 371 of International Application No. PCT/JP2006/324942 filed on Dec. 14, 2006, which in turn claims the benefit of Japanese Application No. 2005-377953, filed on Dec. 28, 2005 and Japanese Application No. 2006-270392, filed on Oct. 2, 2006, the disclosures of which Applications are incorporated by reference herein.

### TECHNICAL FIELD

The present invention relates to non-aqueous electrolyte secondary batteries, and more particularly to non-aqueous electrolyte secondary batteries using a high-capacity negative electrode and having excellent charge-discharge characteristics.

### BACKGROUND ART

With the advancement of portable and cordless electronic instruments, there is a growing expectation for non-aqueous electrolyte secondary batteries smaller in size, lighter in weight, and higher in energy density. In the circumstances, carbon materials such as graphite are used in practical applications as a negative electrode active material for non-aqueous electrolyte secondary batteries. In an attempt to achieve a much higher energy density, the main effort now is to increase the packing density of the active material in the electrodes.

Carbon materials such as graphite have a theoretical capacity density of 372 mAh/g. In order to increase the energy density of non-aqueous electrolyte secondary batteries, attempts are made to use the following as the negative electrode active material: silicon (Si), tin (Sn), germanium (Ge), oxides thereof, and alloys thereof. These elements can form an alloy with lithium having a large theoretical capacity density. These materials have a higher theoretical capacity density than carbon materials. In particular, silicon-containing particles such as silicon particles and silicon oxide particles are widely studied because they are inexpensive.

These negative electrode active material particles, however, change their volume during charging and discharging. When an active material of the negative electrode is packed in a high packing density, the change in volume can sometimes cause the electrolyte solution to be squeezed out from the electrode assembly formed by winding a positive electrode, a negative electrode, and a separator together. This may make it impossible to ensure the amount of electrolyte solution necessary for charge-discharge reactions. Moreover, when such a material having a large volume change is used as the active material, the active material particles are broken into fine particles along with the charge-discharge reactions so as to reduce the conductivity between the particles. As a result, charge-discharge cycle characteristics (hereinafter, cycle characteristics) are not satisfactory.

To solve this problem, it is proposed that the active material particles containing a metal or a semimetal that can form an alloy with lithium are used as the cores and bonded to carbon fibers so as to be formed into composite particles. Such a technique is disclosed in Japanese Patent Application Unexamined Publication No. 2004-349056. It is reported that this structure can ensure the conductivity even if the active material particles change in volume, thereby maintaining sufficient cycle characteristics.

Electrodes (positive electrode and negative electrode) for non-aqueous electrolyte secondary batteries are generally produced by applying a paste of an active material-containing mixture to a metallic foil which works as a current collector and drying it. The dried electrode may often be roll-pressed to achieve higher density and desired thickness. In a negative electrode containing the mixture layer thus formed, the active material repeats expansion and contraction during charging and discharging, thereby causing the mixture layer to have projections and depressions or damage on the surface thereof. In particular, the mixture layer that is formed inner side of the current collector is subjected to a strong compressive stress when the negative electrode is wound together with a positive electrode and a separator to form an electrode assembly. Therefore, the damage to the mixture layer is increased when its surface is thus subjected to the distortion stress due to the expansion and contraction during charging and discharging. In this manner, the mixture layer of the negative electrode has significant strain. This phenomenon causes the breakdown of the conductive network in the mixture layer, the exfoliation of the mixture layer from the current collector, the asymmetrical facing arrangement of the positive and negative electrodes, and the exhaustion of the electrolyte solution. As a result, the cycle characteristics are deteriorated.

### SUMMARY OF THE INVENTION

The present invention is directed to provide anon-aqueous electrolyte secondary battery having improved cycle characteristics, which are achieved by reducing the distortion stress on the mixture layer of the negative electrode due to the volume change of the active material during charging and discharging. The non-aqueous electrolyte secondary battery of the present invention has a positive electrode including a positive electrode mixture layer, a negative electrode, and a non-aqueous electrolyte disposed therebetween. The negative electrode includes a negative electrode mixture layer containing an active material capable of storing and emitting lithium ions, and a current collector supporting the negative electrode mixture layer. The negative electrode mixture layer is provided with a plurality of mixture-layer expansion-absorbing grooves formed in such a manner as to expose the current collector in the position facing the positive electrode mixture layer on the surface of the negative electrode mixture layer. This structure makes the mixture-layer expansion-absorbing grooves to absorb the volume change of the mixture layer due to the expansion and contraction of the active material during charging and discharging, thereby improving cycle characteristics.

### BRIEF DESCRIPTION OF THE DRAWINGS

FIG. 1 is a sectional view of a non-aqueous electrolyte secondary battery according to a first exemplary embodiment of the present invention.

FIG. 2A is a partial plan view showing a structure of a negative electrode of the non-aqueous electrolyte secondary battery according to the first exemplary embodiment of the present invention.

FIG. 2B is a partial plan view of the negative electrode of FIG. 2A in a charged state.

FIG. 2C is a partial sectional view taken along line A-A of FIG. 2A.

FIG. 2D is a partial sectional view taken along line A-A of FIG. 2B.

FIG. 3A is a partial plan view showing another structure of a negative electrode of a non-aqueous electrolyte secondary battery according to the first exemplary embodiment of the present invention.

FIG. 3B is a partial plan view of the negative electrode of FIG. 3A in a charged state.

FIG. 3C is a partial sectional view taken along line A-A of FIG. 3A.

FIG. 3D is a partial sectional view taken along line A-A of FIG. 3B.

FIG. 4 is a partially enlarged sectional view showing a schematic structure of the negative electrode of the non-aqueous electrolyte secondary battery according to the first exemplary embodiment of the present invention.

FIG. 5A is a partial sectional view showing a structure of a wound electrode assembly of a non-aqueous electrolyte secondary battery according to a second exemplary embodiment of the present invention.

FIG. 5B is an enlarged schematic sectional view of a part of FIG. 5A.

FIG. 5C is a schematic sectional view showing a negative-electrode mixture layer of FIG. 5A in a charged state.

FIG. 6 is a schematic view of manufacturing equipment for forming columnar bodies of a negative electrode active material on a current collector according to a third exemplary embodiment of the present invention.

FIG. 7A is a schematic sectional view of the current collector used in the manufacturing equipment shown in FIG. 6.

FIG. 7B is a schematic sectional view showing first-stage columnar portions of the negative electrode active material formed on the current collector of FIG. 7A.

FIG. 7C is a schematic sectional view showing a state in which second-stage columnar portions are formed on the first-stage columnar portion, following FIG. 7B.

FIG. 7D is a schematic sectional view showing a state in which third-stage columnar portions are formed on the second-stage columnar portions, following FIG. 7C.

### DETAILED DESCRIPTION OF PREFERRED EMBODIMENTS

Exemplary embodiments of the present invention are described as follows with reference to drawings. Note that the present invention is not limited to the following description except for its fundamental features.

### First Exemplary Embodiment

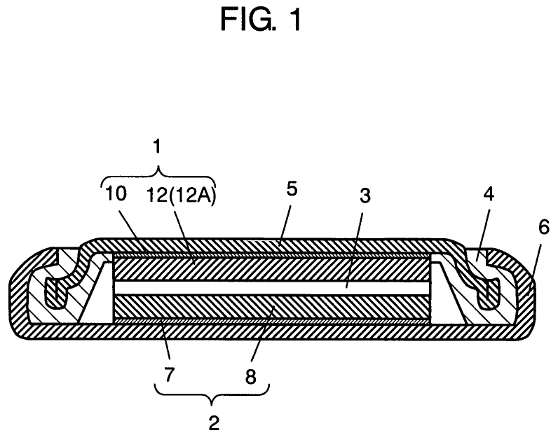

FIG. 1 is a sectional view of a non-aqueous electrolyte secondary battery according to a first exemplary embodiment of the present invention. This coin-shaped battery includes negative electrode 1, positive electrode 2 which is disposed opposite to negative electrode 1 and reduces lithium ions during discharge, and non-aqueous electrolyte 3 interposed between negative electrode 1 and positive electrode 2 so as to conduct lithium ions. Negative electrode 1 and positive electrode 2 are housed in case 6 with non-aqueous electrolyte 3 using gasket 4 and lid 5. Positive electrode 2 includes current collector 7 and positive-electrode mixture layer 8 which contains a positive electrode active material. Negative electrode 1 includes current collector 10 and negative-electrode mixture layer (hereinafter, mixture layer) 12 formed on a surface of current collector 10.

Mixture layer 12 includes a silicon-containing material as an active material capable of storing and emitting at least lithium ions. Mixture layer 12 further includes a binder. Examples of the binder include polyvinylidene fluoride (PVDF), polytetrafluoroethylene (PTFE), polyethylene, polypropylene, aramid resin, polyamide, polyimide, polyamideimide, polyacrylonitrile, polyacrylic acid, poly methyl acrylate, poly ethyl acrylate, poly hexyl acrylate, polymethacrylic acid, poly methyl methacrylate, poly ethyl methacrylate, poly hexyl methacrylate, polyvinyl acetate, polyvinylpyrrolidone, polyether, polyethersulfone, hexafluoropolypropylene, styrene-butadiene rubber, and carboxymethyl cellulose. Other examples of the binder include copolymers containing at least two selected from tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene.

Mixture layer 12 may also contain the following conductive agent when necessary. Specific examples of the conductive agent include graphites such as expanded graphite, artificial graphite, and natural graphite such as scaly graphite; carbon blacks such as acetylene black, Ketjen black, channel black, furnace black, lamp black, and thermal black; conductive fibers such as carbon fiber and metal fiber; metal powders such as copper powder and nickel powder; and organic conductive materials such as polyphenylene derivatives.

Current collector 10 can be made of a metal foil such as stainless steel, nickel, copper or titanium, or a thin film such as carbon or conductive resin. These materials may be surface-treated with carbon, nickel, titanium or the like.

The following is a description of positive electrode 2. Positive-electrode mixture layer 8 includes a lithium-containing complex oxide as a positive electrode active material, such as LiCoO₂, LiNiO₂, Li₂MnO₄, or a mixture or composite thereof. Specific examples of the positive electrode active material other than the lithium-containing complex oxides mentioned above include olivine-type lithium phosphate expressed by a general formula: LiMPO₄ where M=V, Fe, Ni, or Mn, and lithium fluorophosphates expressed by a general formula: Li₂ MPO₄F where M=V, Fe, Ni, or Mn. It is also possible to replace part of the constituent elements of these lithium-containing compounds by a different element. The surfaces of the lithium-containing compounds may be treated with a metal oxide, a lithium oxide, a conductive agent or the like, or may be subjected to hydrophobic treatment.

Positive-electrode mixture layer 8 further includes a conductive agent and a binder. Specific examples of the conductive agent include graphites such as natural graphite and artificial graphite; carbon blacks such as acetylene black, Ketjen black, channel black, furnace black, lamp black, and thermal black; conductive fibers such as carbon fiber and metal fiber; metal powders such as aluminum powder; conductive whiskers such as zinc oxide and potassium titanate; conductive metal oxides such as titanium oxide; and organic conductive materials such as phenylene derivatives.

The binder for positive electrode 2 can be the same as for negative electrode 1. Specific examples of the binder include PVDF, polytetrafluoroethylene, polyethylene, polypropylene, aramid resin, polyamide, polyimide, polyamideimide, polyacrylonitrile, polyacrylic acid, poly methyl acrylate, poly ethyl acrylate, poly hexyl acrylate, polymethacrylic acid, poly methyl methacrylate, poly ethyl methacrylate, poly hexyl methacrylate, polyvinyl acetate, polyvinylpyrrolidone, polyether, polyethersulfone, hexafluoropolypropylene, styrene-butadiene rubber, and carboxymethyl cellulose. Other examples of the binder include copolymers containing at least two selected from tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene. It is also possible to mix two or more of these.

Current collector 7 can be made of stainless steel, aluminum (Al), titanium, carbon, a conductive resin, or the like. These materials may be surface-treated with carbon, nickel, titanium, or the like.

Non-aqueous electrolyte 3 may be made of an electrolyte solution containing an organic solvent and a solute dissolved in the solvent or of a so-called polymer electrolyte containing an electrolyte solution immobilized in a polymer. At least in the case of using an electrolyte solution, it is preferable to provide a separator (unillustrated) impregnated with the electrolyte solution between positive electrode 2 and negative electrode 1. The separator can be nonwoven fabric or microporous membrane made of polyethylene, polypropylene, an aramid resin, amideimide, polyphenylene sulfide, or polyimide. The separator may also contain heat-resistant filler such as alumina, magnesia, silica, or titania either inside or on a surface thereof. Besides the separator, there can be used a heat-resistant layer which is composed of one of the fillers and the same binder as used in the electrodes.

The material of non-aqueous electrolyte 3 is selected based on the oxidation-reduction potentials of the active materials and other conditions. As the solute for non-aqueous electrolyte 3, salts commonly used in lithium batteries can be used. Examples of the salt include LiPF₆, LiBF₄, LiClO₄, LiAlCl₄, LiSbF₆, LiSCN, LiCF₃SO₃, LiCF₃CO₂, LiAsF₆, LiB₁₀Cl₁₀, lower aliphatic lithium carboxylate, LiF, LiCl, LiBr, LiI, chloroborane lithium; various borates such as lithium bis(1,2-benzenediolate (2-)-O,O′) borate, lithium bis(2,3-naphthalenediolate (2-)-O,O′) borate, lithium bis(2,2′-biphenyldiolate (2-)-O,O′) borate, lithium bis(5-fluoro-2-olate-1-benzenesulfonic acid-O,O′) borate; (CF₃SO₂)₂NLi, LiN(CF₃SO₂), (C₄F₉SO₂), (C₂F₅SO₂)₂NLi, and lithium tetraphenyl borate.

As the organic solvent in which the aforementioned solutes are dissolved, solvents commonly used in lithium batteries can be used. Examples of the organic solvent include the following which can be used either on their own or in combination: ethylene carbonate, propylene carbonate, butylene carbonate, vinylene carbonate, dimethyl carbonate, diethyl carbonate, ethyl methyl carbonate, dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxymethoxyethane, trimethoxymethane, tetrahydrofuran, tetrahydrofuran derivatives such as 2-methyl-tetrahydrofuran, dimethyl sulfoxide, 1,3-dioxolane, dioxolane derivatives such as 4-methyl-1,3-dioxolane, formamide, acetamide, dimethylformamide, acetonitrile, propylnitrile, nitromethane, ethylmonoglyme, trimester phosphate, acetate ester, propionate ester, sulfolane, 3-methyl-sulfolane, 1,3-dimethyl-2-imidazolidinone, 3-methyl-2-oxazolidinone, propylene carbonate derivatives, ethyl ether, diethyl ether, 1,3-propane sultone, anisole, and fluorobenzene.

Non-aqueous electrolyte 3 may further contain an additive such as vinylene carbonate, cyclohexylbenzene, biphenyl, diphenyl ether, vinylethylene carbonate, divinylethylene carbonate, phenylethylene carbonate, diallyl carbonate, fluoroethylene carbonate, catechol carbonate, vinyl acetate, ethylene sulfite, propane sultone, trifluoropropylene carbonate, dibenzofuran, 2,4-difluoroanisole, o-terphenyl, or m-terphenyl.

Non-aqueous electrolyte 3 may alternatively be used in the form of a solid polymer electrolyte by either adding the aforementioned solute to or dissolving it in the following polymeric materials which are used either on their own or in combination: poly(ethylene oxide), poly(propylene oxide), polyphosphazene, polyaziridine, polyethylene sulfide, polyvinyl alcohol, polyvinylidene fluoride, and polyhexafluoropropylene. The solid polymer electrolyte may be mixed with one of the aforementioned organic solvents so as to be used in the form of a gel. Non-aqueous electrolyte 3 may alternatively be used in the form of a solid electrolyte made of an inorganic material such as a lithium nitride, a lithium halide, lithium oxoate, Li₄SiO₄, Li₄SiO₄—LiI—LiOH, Li₃PO₄—Li₄SiO₄, Li₂SiS₃, Li₃PO₄—Li₂S—SiS₂, or phosphorus sulfide compounds.

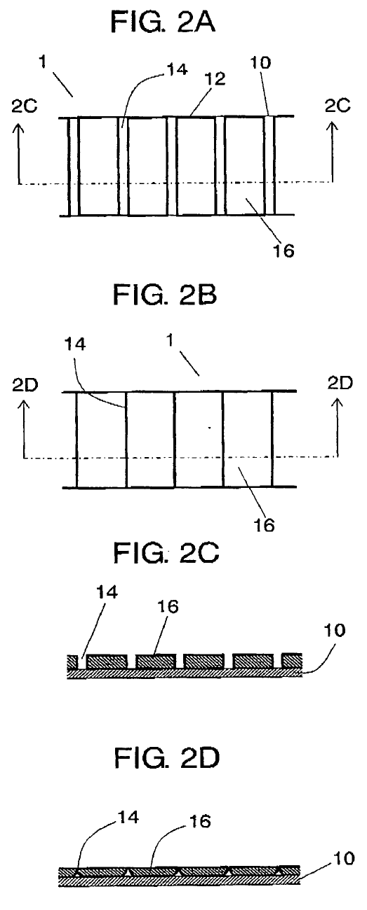

The following is a description of the structure of negative electrode 1 and its changes during charging and discharging according to the present embodiment. FIGS. 2A to 2D show the structure of the negative electrode for the non-aqueous electrolyte secondary battery according to the first exemplary embodiment of the present invention. More specifically, FIG. 2A is a partial plan view of the negative electrode prior to charging. FIG. 2C is a partial sectional view taken along line A-A of FIG. 2A. FIG. 2B is a partial plan view of the negative electrode in a charged state. FIG. 2D is a partial sectional view taken along line A-A of FIG. 2B. Mixture layer 12 substantially returns to the states shown in FIGS. 2A and 2C respectively from the states shown in FIGS. 2B and 2D when discharge is complete.

As shown in FIGS. 2A to 2D, at least one surface of current collector 10 is coated with mixture layer 12 in which carbon nanofibers (hereinafter, CNFs) are bonded to the surface of a silicon-containing material. Mixture layer 12 is divided into blocks 16 by forming parallel mixture-layer expansion-absorbing grooves (hereinafter, grooves) 14 in such a manner as to expose current collector 10. Grooves 14 are formed in the position facing positive-electrode mixture layer 8.

In mixture layer 12 thus structured, blocks 16 partitioned by grooves 14 expand during charging as shown in FIG. 2D. In this structure, however, the volume change is absorbed by grooves 14. When charging is complete, the adjacent ones of blocks 16 of mixture layer 12 come close to or into contact with each other at their surface portions. This prevents mixture layer 12 from being entirely distorted due to the compressive stress caused by the volume increase of blocks 16 or from having a wavy surface with depressions and projections. In this manner, grooves 14 work to reduce the distortion of mixture layer 12 due to the expansion and contraction of the active material during charging and discharging. Providing grooves 14 prevents the breakdown of the conductive network in mixture layer 12, the exfoliation of mixture layer 12 from current collector 10, and the uneven arrangement of negative electrode 1 to positive electrode 2, particularly in a charged state. Grooves 14 also work to supply the electrolyte solution when it is decreased due to the expansion of mixture layer 12.

Mixture layer 12 is formed on one side of current collector 10 in FIGS. 2A to 2D, but can be formed on both sides. In some battery structures described later, mixture layer 12 on a side of current collector 10 does not have to have grooves 14 therein.

Mixture layer 12 having grooves 14 which are the feature of the present embodiment exerts its effect most effectively when it contains a silicon-containing material capable of storing and emitting lithium ions. The reason for this is described as follows. By way of comparison, when a negative electrode mixture layer contains a carbon material as an active material, grooves 14 have little effect of stress relaxation because the negative electrode has a very small volume change during charging. In addition, the reaction potential between the carbon material and lithium ions is nobler only by several tens of microvolts than the dissolution and deposition potential of metallic lithium. Therefore, if polarization is produced by reaction resistance, the local potential becomes 0V or below, thereby sometimes causing metallic lithium to be deposited on current collector 10. When the mixture layer of such a negative electrode is provided with grooves 14 to which current collector 10 is exposed, it facilitates the deposition of the metallic lithium, thereby causing a large decrease in the cycle characteristics. Since this phenomenon is remarkable when the charge current is large, it is preferable to have a small charge current.

In contrast, a mixture layer containing an active material such as silicon-containing particles that has a comparatively high volume change during charging but a high capacity density reacts with lithium ions at a potential as high as several hundreds of microvolts. Therefore, even if polarization is produced by reaction resistance, the local potential is unlikely to be 0V or below. Providing grooves 14 allows to absorb the expansion and contraction of mixture layer 12 and also to prevent the deposition of metallic lithium on current collector 10, thereby improving the cycle characteristics.

Examples of the material having such a reaction potential and capable of storing and emitting a large amount of lithium ions include silicon (Si) and tin (Sn), which have a ratio of a volume A in a charged state to a volume B in a discharged state (A/B) of 1.2 or more. These materials contribute greatly to higher energy density of non-aqueous electrolyte secondary batteries because of their large capacity density. These materials also expand greatly in a charged state, making the effect of the mixture-layer expansion-absorbing grooves remarkably. Silicon-containing particles are a typical example of the aforementioned active material because of their large volume change during charging and discharging and large capacity density.

These materials can exert the effect of the present invention whether they are elemental substances, alloys, compounds, solid solutions, or composite active materials such as a silicon-containing material and a tin-containing material. More specifically, the silicon-containing material can be made of Si or SiOₓ where 0.05≦x≦1.95, or can be an alloy, a compound, a solid solution, or the like in which Si is partly replaced by one or more elements selected from the group consisting of B, Mg, Ni, Ti, Mo, Co, Ca, Cr, Cu, Fe, Mn, Nb, Ta, V, W, Zn, C, N, and Sn. The tin-containing material can be Ni₂Sn₄, Mg₂Sn, SnOₓ where 0≦x≦2, SnO₂, SnSiO₃, LiSnO or the like.

These elements can compose the active material either on their own or in combination. Examples of composing the active material in combination include a composite of a Si—O compound and a Si—N compound, and a composite of a plurality of compounds which contain silicon and oxygen in different ratios. Of these, SiOₓ where 0.05≦x≦1.95 is desirable because of its large discharge capacity density and smaller expansion coefficient during charging than pure silicon.

In order to absorb the volume change of mixture layer 12 due to the expansion and contraction during charging and discharging, grooves 14 are required to be formed in such a manner as to expose current collector 10. Grooves that can only reduce the thickness of mixture layer 12 cannot eliminate the distortion caused by the volume change of mixture layer 12. The width and spacing of grooves 14, that is, the optimum geometric range of blocks 16 of mixture layer 12 depend mainly on the thickness of mixture layer 12. For example, as a general principle, when mixture layer 12 has a thickness of about 70 μm at one side and the electrode assembly has a winding diameter of about 18 mm, grooves 14 are required to have a width of 0.2 mm to 3 mm and a spacing of 12 mm to 56 mm. Grooves 14 can be formed, for example, by linearly exfoliating part of mixture layer 12 at a predetermined spacing by using a PTFE bar whose diameter corresponds to the width of grooves 14.

Grooves 14 have several kinds of structures, and any structure can be chosen to achieve the effect of the present invention. Preferably, grooves 14 divide mixture layer 12 into independent blocks 16 as shown in FIGS. 2A to 2D. This structure increases the isotropy of mixture layer 12 to increase its volume so as not to be expanded at random directions, thereby reducing the distortion.

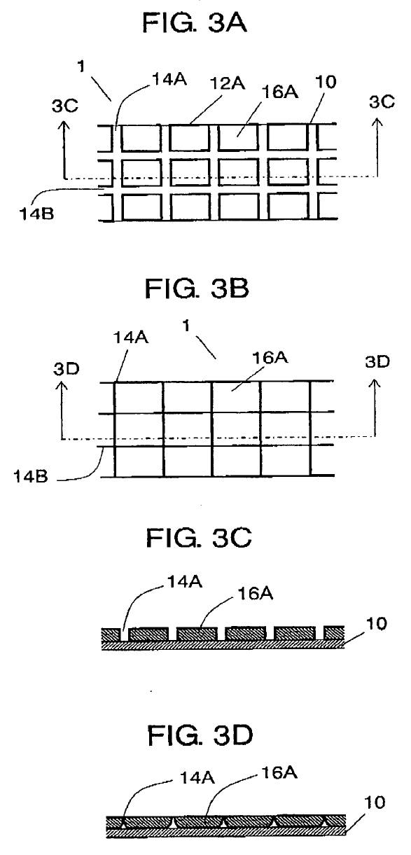

The following is a description of another structure of the mixture-layer expansion-absorbing grooves. FIGS. 3A to 3D show another structure of the negative electrode of the non-aqueous electrolyte secondary battery according to the first exemplary embodiment of the present invention. FIG. 3A is a partial plan view of the negative electrode prior to charging. FIG. 3B is a partial plan view of the negative electrode after charging is complete. FIG. 3C is a partial sectional view taken along line A-A of FIG. 3A. FIG. 3D is a partial sectional view taken along line A-A of FIG. 3B. The sectional views of FIGS. 3C and 3D are similar to those shown in FIGS. 2C and 2D, respectively.

As shown in FIG. 3A, the present structure has grooves consisting of longitudinal grooves 14A and lateral grooves 14B crossing each other. Longitudinal grooves 14A and lateral grooves 14B are longitudinal and lateral, respectively, to current collector 10. Consequently, each of blocks 16A of negative-electrode mixture layer (hereinafter, mixture layer) 12A is shaped in a square formed by two of longitudinal grooves 14A and two of lateral grooves 14B. When discharge is complete, mixture layer 12A substantially returns to the states shown in FIGS. 3A and 3C from the states shown in FIGS. 3B and 3D. The non-aqueous electrolyte secondary battery employing this structure has the same fundamental structure as the battery shown in FIG. 1.

In this structure, blocks 16A may be rectangular or square. As shown in the plan view of FIG. 3B and the sectional view of FIG. 3D, when expanded during charging, the adjacent ones of blocks 16A of mixture layer 12A come close to or into contact with each other at their top surface edges. Then, the expanded portions of blocks 16A are accommodated in longitudinal grooves 14A and lateral grooves 14B.

The planar shape of mixture layer 12A divided into blocks 16A by grooves 14A and 14B is not limited to the aforementioned shape. The effect of the present embodiment can be achieved as long as mixture layer 12A is provided with grooves that can absorb the volume change of mixture layer 12A due to its expansion and contraction during charging and discharging. For example, grooves 14A and 14B can be not parallel or perpendicular to, but diagonal to or curved along the lateral direction of negative electrode 1.

Also in this structure, the optimum range of the width and spacing of grooves 14A and 14B depend mainly on the thickness of mixture layer 12A. For example, when mixture layer 12A has a thickness of about 70 μm and the electrode assembly has a diameter of about 18 mm, grooves 14A and 14B 4 preferably have a width of 0.2 mm to 3 mm and a spacing of 12 mm to 56 mm.

Grooves 14A and 14B are not necessarily arranged at regular spacings. When the electrode assembly is wound as will be described later. The compressive stress due to the volume change of mixture layer 12A during charging and discharging affects most in the vicinity of the winding center, which has a high curvature. Therefore, grooves 14A and 14B can be formed only in the vicinity of the winding center. Alternatively, grooves 14A and 14B can be arranged at small spacings in the vicinity of the winding center and at increasingly larger spacings toward the periphery.

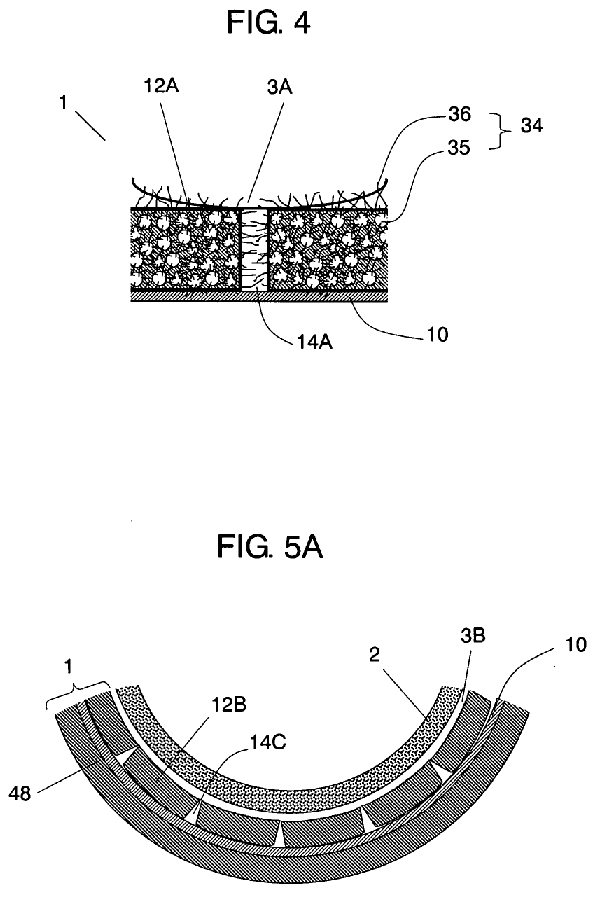

The following is a description of a negative electrode active material preferably used in mixture layer 12A and the structure of negative electrode 1. FIG. 4 is a partially enlarged sectional view of negative electrode 1. Mixture layer 12A formed with grooves 14A on the surface of current collector 10 includes composite negative electrode active material (hereinafter, composite) 34. Composite 34 includes a silicon-containing material or silicon-containing particles 35, which are an active material capable of storing and emitting lithium ions, and carbon nanofibers (CNFs) 36 attached to silicon-containing particles 35. CNFs 36 are grown using catalytic elements (unillustrated) as nuclei which are supported on the surfaces of silicon-containing particles 35. The catalytic elements are at least one selected from the group consisting of Cu, Fe, Co, Ni, Mo, and Mn, and promote the growth of CNFs 36. Silicon-containing particles 35 may be replaced as another active material by the aforementioned material capable of storing and emitting a large amount of lithium ions and having a ratio of the volume A in a charged state to the volume B in a discharged state (A/B) of 1.2 or more.

Mixture layer 12A has CNFs 36 having a fiber length of 1 nm to 1 mm on the surface thereof. Composite 34 reacts with lithium ions at a potential higher than the deposition potential of lithium. Therefore, an appropriate charge current value can prevent the lithium ions from directly reaching the exposed surface of current collector 10, thereby preventing the dendritic deposition of metallic lithium on the exposed surface of current collector 10.

The following is a detailed description of composite 34. CNFs 36 are attached or fixed to the surface of each of silicon-containing particles 35 in the presence of the catalytic element which is the start point of the growth of CNFs 36. This structure reduces the resistance for current collection, thereby maintaining high electron conductivity in the battery. Bonding CNF 36 to silicon-containing particle 35 in the presence of the catalytic element is preferable because it makes CNF 36 less likely to dissociate from silicon-containing particle 35. The catalytic element promotes the growth of CNF 36 on the surface of silicon-containing particle 35 which work as the active material, thereby making the conductive network stronger between silicon-containing particles 35.

The attachment of CNFs 36 to the surface of silicon-containing particle 35 increases the conductivity, thereby providing the non-aqueous electrolyte secondary battery with a high capacity, practicality, and excellent charge-discharge characteristics. The intervention of the catalytic element increases the bond between CNFs 36 and silicon-containing particle 35. Due to the increased bond, the negative electrode becomes more resistant to the roll-pressing load, which is the mechanical load to be applied to mixture layer 12A in order to improve its packing density when it is formed on current collector 10.

In order to allow the catalytic element to exhibit excellent catalytic activity until CNFs 36 are fully grown, the catalytic element is preferably present in a metallic state in the surface parts of silicon-containing particle 35. More specifically, the catalytic element is preferably present in the form of metal particles having a diameter of, for example, 1 nm to 1000 nm. On the other hand, when the growth of CNFs 36 is complete, the metal particles of the catalytic element are preferably oxidized.

CNF 36 has a fiber length of preferably 1 nm to 1 mm, and more preferably 500 nm to 100 μm. When the fiber length is less than 1 nm, the effect to increase the conductivity in the electrode is too small. In contrast, the fiber length of over 1 mm tends to reduce the active material density or capacity of the electrode. In the present embodiment, mixture layer 12A is provided with grooves 14A and 14B in which a part of current collector 10 is exposed. Therefore, it is particularly preferable that CNF 36 has a long fiber length in order to prevent electrolyte solution 3A from coming into contact with current collector 10.

Although not limited, CNF 36 is preferably in the form of at least one selected from the group consisting of a tube shape, an accordion shape, a plate shape, and a herringbone shape. CNF 36 may absorb the catalytic element during its growth. CNF 36 has a fiber diameter of preferably 1 nm to 1000 nm, and more preferably 50 nm to 300 nm.

The catalytic element in a metallic state works as an active site to grow CNF 36. More specifically, CNFs 36 start to grow when silicon-containing particles 35 with the catalytic element exposed in a metallic state on their surfaces are introduced into a high-temperature atmosphere containing the source gas of CNFs 36. When the active material particles have no catalytic element on their surfaces, CNFs 36 do not grow.

Methods for providing metal particles of the catalytic element on the surfaces of silicon-containing particles 35 are not particularly limited; however, it is preferable to use a method for supporting metal particles on the surfaces of silicon-containing particles 35.

When the metal particles are supported by the aforementioned method, it is possible to mix silicon-containing particles 35 with the metal particles in solid form. It is preferable to soak silicon-containing particles 35 in a solution of a metal compound which is the source material of the metal particles. After the soaking, the solvent is removed from silicon-containing particles 35, which can be heated if necessary. This process allows to obtain silicon-containing particles 35 supporting on their surfaces the catalytic element in the form of metal particles having a diameter of 1 nm to 1000 nm, and preferably 10 nm to 100 nm in a highly and uniformly dispersed state.

It is difficult to form the metal particles of the catalytic element having a diameter of less than 1 nm. On the other hand, when formed to have a diameter of over 1000 nm, the metal particles may be extremely uneven in size, making it difficult to grow CNFs 36 or to form a highly conductive electrode. Therefore, the diameter of the metal particles of the catalytic element is preferably 1 nm or more and 1000 nm or less.

Specific examples of the metal compound to obtain the aforementioned solution include nickel nitrate, cobalt nitrate, iron nitrate, copper nitrate, manganese nitrate, and hexaammonium heptamolybdate tetrahydrate. The solvent used for the solution can be selected from water, an organic solvent and a mixture of water and an organic solvent as appropriate according to the solubility of the compound and the compatibility of the compound with the electrochemical active phase contained in silicon-containing particle 35. The electrochemical active phase means a crystalline phase or an amorphous phase such as a metallic phase or a metal-oxide phase that can induce an oxidation-reduction reaction involving electron transfer, that is, a cell reaction, out of the crystalline and amorphous phases composing silicon-containing particles 35. Specific examples of the organic solvent include ethanol, isopropyl alcohol, toluene, benzene, hexane, and tetrahydrofuran.

Alternatively, it is also possible to synthesize alloy particles containing the catalytic element and to use this as silicon-containing particles 35. This synthesis between Si and the catalytic element is performed by a common alloying method. Silicon reacts electrochemically with lithium to form an alloy, thereby forming the electrochemical active phase in silicon-containing particle 35. On the other hand, the metallic phase of the catalytic element are at least partly exposed in the form of particles having a diameter of 10 nm to 100 nm on the surface of the alloy particle.

The metal particles or the metallic phase of the catalytic element are preferably 0.01 wt % to 10 wt % of silicon-containing particles 35, and more preferably 1 wt % to 3 wt %. When the content of the metal particles or the metallic phase is too low, it may take a lot of time to grow CNFs 36, thereby decreasing production efficiency. In contrast, when the content is too high, the catalytic element agglomerates, causing CNFs 36 to have large and uneven fiber diameters. This leads to a decrease in the conductivity and active material density of the mixture layer. This also leads to a decrease in the proportion of the electrochemical active phase, making it difficult to use composite 34 as a high-capacity electrode material.

The following is a description of a method for producing composite 34 composed of silicon-containing particle 35 and CNFs 36. This production method includes the following four steps (a) to (d).

(a) A step of loading the catalytic element at least in the surface part of each of silicon-containing particles 35 that can store and emit lithium ions. The catalytic element is at least one selected from the group consisting of Cu, Fe, Co, Ni, Mo, and Mn which promote the growth of CNF 36.

(b) A step of growing CNFs 36 on the surface of silicon-containing particle 35 in an atmosphere containing carbon-containing gas and hydrogen gas.

(c) A step of sintering silicon-containing particles 35 with CNFs 36 attached thereto in an inert gas atmosphere at 400° C. or more and 1600° C. or less.

(d) A step of crushing silicon-containing particles 35 with CNFs 36 attached thereto so as to adjust the tap density of silicon-containing particles 35 to 0.42 g/cm³ or more and 0.91 g/cm³ or less.

After Step (c), composite 34 can be subjected to heat treatment in the air at 100° C. or more and 400° C. or less so as to oxidize the catalytic element. The heat treatment at this temperature range can oxidize only the catalytic element without oxidizing CNFs 36.

As Step (a), there may be mentioned a step of supporting the metal particles of the catalytic element on the surfaces of silicon-containing particles 35; a step of reducing the surfaces of silicon-containing particles 35 containing the catalytic element; a step of synthesizing alloy particles of silicon and the catalytic element. Step (a) is not limited thereto.

The following is a description of conditions when CNFs 36 are grown on the surface of silicon-containing particle 35 in Step (b). CNFs 36 start to grow when silicon-containing particle 35 having the catalytic element at least in the surface thereof are introduced into a high-temperature atmosphere containing the source gases of CNFs 36. For example, silicon-containing particles 35 are placed in a ceramic reaction vessel and heated to high temperatures of 100° C. to 1000° C., and preferably to 300° C. to 600° C. in an inert gas or a gas having reducing capacity. Then, carbon-containing gas and hydrogen gas, which are the source gases of CNFs 36, are introduced into the reaction vessel. When the temperature in the reaction vessel is less than 100° C., CNFs 36 either do not grow or grow very slowly, thereby damaging the productivity. In contrast, when the temperature in the reaction vessel exceeds 1000° C., the source gases are decomposed rapidly, making it harder to grow CNFs 36.

The source gases are preferably a mixture gas of carbon-containing gas and hydrogen gas. Specific examples of the carbon-containing gas include methane, ethane, ethylene, butane, and carbon monoxide. The molar ratio (volume ratio) of the carbon-containing gas in the mixture gas is preferably 20% to 80%. When the catalytic element in a metallic state are not exposed on the surfaces of silicon-containing particles 35, the proportion of the hydrogen gas can be increased to perform the reduction of the catalytic element and the growth of CNFs 36 in parallel. When the growth of CNFs 36 is terminated, the mixture gas of the carbon-containing gas and the hydrogen gas is replaced by an inert gas and the inside of the reaction vessel is cooled to room temperature.

Using silicon oxide particles in a composition range expressed by SiOₓ where 0.05≦x≦1.95 as silicon-containing particles 35 is desirable in order to facilitate CNFs 36 to be attached to the surfaces of silicon-containing particles 35.

Next, in Step (c), silicon-containing particles 35 having CNFs 36 attached thereto are fired in an inert gas atmosphere at 400° C. or more and 1600° C. or less. This firing is preferable because it can prevent the irreversible reaction between the electrolyte and CNFs 36 which progresses at the initial charge of the battery, thereby achieving excellent charge-discharge efficiency of the battery. When such firing process is either not performed or performed at a temperature less than 400° C., the irreversible reaction may not be prevented, causing a decrease in the charge-discharge efficiency. In contrast, when firing temperatures exceed 1600° C., the electrochemical active phase of silicon-containing particles 35 reacts with CNFs 36 and may be inactivated or reduced, so that the battery capacity may be decreased. For example, when the electrochemical active phase of silicon-containing particles 35 are made of silicon, silicon reacts with CNFs 36 to generate inert silicon carbide, thereby causing a decrease in the charge-discharge capacity of the battery. When silicon-containing particles 35 are made of silicon, the firing temperature is particularly preferably 1000° C. or more and 1600° C. or less. Some growth conditions could improve the crystallinity of CNFs 36. When CNFs 36 have high crystallinity, the irreversible reaction between the electrolyte and CNFs 36 can be prevented. In this case, Step (c) is not necessary.

After being fired in the inert gas, composite 34 is preferably heat-treated in the air at 100° C. or more and 400° C. or less in order to oxidize at least parts (surfaces, for example) of the metal particles or the metallic phase of the catalytic element. When the heat-treatment temperature is less than 100° C., it is difficult to oxidize the metal, whereas temperatures exceeding 400° C. may burn CNFs 36 thus grown.

In Step (d), fired silicon-containing particles 35 with CNFs 36 attached thereto are crushed. Crushing is preferred because the particles of composite 34 achieve good packing ability (compactability). However, when the tap density is 0.42 g/cm³ or more and 0.91 g/cm³ or less, crushing may not be necessary. In other words, when silicon-containing particles with excellent compactability are used as a source material, crushing may not be necessary.

Note that composite 34 can be applied to the structure shown in FIGS. 2A to 2D.

### Second Exemplary Embodiment

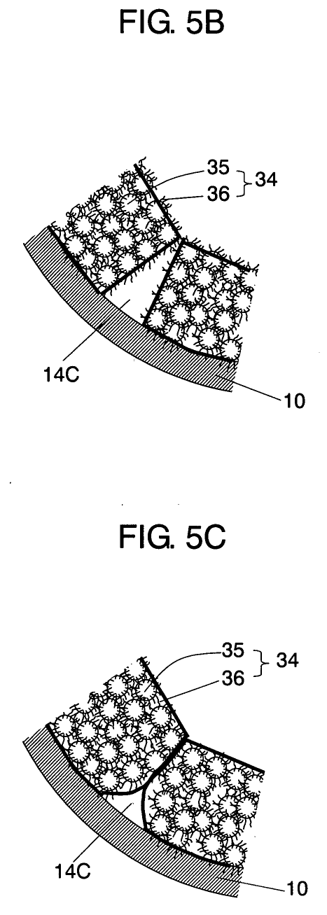

FIG. 5A is a partial sectional view showing a structure of a non-aqueous electrolyte secondary battery according to a second exemplary embodiment of the present invention formed by winding a positive electrode and a negative electrode together. FIGS. 5B and 5C are enlarged schematic sectional views of a part of FIG. 5A: FIG. 5B shows a discharged state and FIG. 5C shows a charged state. The non-aqueous electrolyte secondary battery according to the present embodiment includes an electrode assembly formed by winding negative electrode 1 and positive electrode 2 with separator 3B interposed therebetween. Positive electrode 2 has a structure in which the current collector has a mixture layer on both sides thereof. The other features of positive electrode 2 will not be described in detail.

As shown in FIG. 5A, current collector 10 made of Cu foil or the like has negative-electrode mixture layer (hereinafter, mixture layer) 12B on one side and mixture layer 48 on the other side. Mixture layer 12B formed on the inner side in the direction of winding the electrode assembly is provided with mixture-layer expansion-absorbing grooves (hereinafter, grooves) 14C. Grooves 14C are formed in the position facing the positive-electrode mixture layer. As shown in FIGS. 5B and 5C, mixture layer 12B of the present embodiment includes composite 34 described in the first exemplary embodiment.

As shown in FIG. 5C, each block of mixture layer 12B increases its volume during charging due to the expansion of silicon-containing particles 35, each of which is an active material capable of storing and emitting lithium ions. The increased volume is absorbed in grooves 14C so as to reduce the compressive stress due to the expansion and contraction of each block, thereby preventing the occurrence of stress distortion and other problems on the surface of mixture layer 12B. The absence of strain prevents the breakdown of the conductive network in mixture layer 12B, the exfoliation of mixture layer 12B from current collector 10, and the uneven arrangement of negative electrode 1 to positive electrode 2. As a result, the cycle characteristics are improved. Grooves 14C are preferably formed on the inner side of the winding having a high curvature so that grooves 14C can absorb the initial strain due to the compressive stress on the top surface of mixture layer 12B caused during the winding. This further reduces the stress due to the volume change during charging and discharging.

Grooves 14C are more preferably formed substantially perpendicular to the direction of winding negative electrode 1 in order to effectively reduce the initial strain due to the compressive stress on the top surface of mixture layer 12B caused during the winding.

The adjacent ones of the blocks of mixture layer 12B are preferably in contact with each other at their top surface edges. One reason for this is that covering the surface of current collector 10 exposed by grooves 14C with the top surfaces of the adjacent blocks can prevent lithium ions from entering the surface of current collector 10, thereby further reducing the deposition of metallic lithium on current collector 10. Another reason is that the negative-electrode mixture layer can make a continuous surface facing positive electrode 2 via separator 3B, thereby improving the reaction efficiency of positive electrode 2.

As shown in FIG. 5B, mixture layer 12B has CNFs 36 having a fiber length of 1 nm to 1 mm lying on its surface. CNFs 36 are intricately intertwined with each other because the blocks of mixture layer 12B are in contact with each other at their top surface edges. Similar to the case shown in FIG. 4, the lithium ions contained in electrolyte solution 3A are prevented from entering grooves 14C, thereby reducing the deposition of lithium on the exposed surface of current collector 10. Furthermore, CNFs 36, working like tentacles, interconnect the blocks of mixture layer 12B that are partitioned by grooves 14C. This link between CNFs 36 increases the conductivity of mixture layer 12B.

Grooves 14C are preferably arranged at decreasing spacing toward the winding center when the electrode assembly is formed, in order to effectively prevent the occurrence of stress distortion in the winding center during the winding. Although negative electrode 1 includes composite 34 in the aforementioned description, the structure of the present embodiment is effective when negative electrode 1 includes as an active material a silicon-containing material capable of storing and emitting at least lithium ions.

Graphite, which is commonly used as a negative electrode active material expands about 20% when charged. Therefore, when the negative electrode active material is packed at high density, it is preferable to form mixture-layer expansion-absorbing grooves 14C at least on mixture layer 12B that is on the inside of current collector 10 when wound and also to optimize the charge current value. As a result, the cycle characteristics are improved. Of course, the same holds true when a mixture of a silicon-containing material and graphite is used as the negative electrode active material.

The following is a description of specific examples of the present embodiment. All these examples describe spiral-wound cylindrical secondary batteries, but the present invention is also applicable to flat batteries, spiral-wound prismatic batteries, and stacked coin shaped batteries.

### Example 1

### (1) Preparation of Positive Electrode

First, 100 parts by weight of LiNi_{0.8}Cu_{0.17}Al_{0.03}O₂ as a positive electrode active material are mixed with 3 parts by weight of acetylene black as a conductive agent and 4 parts by weight of PVDF as a binder. The resulting mixture is uniformly dispersed in a solvent of N-methylpyrrolidone (NMP) so as to prepare a paste.

The paste is applied to a 15 μm-thick aluminum (Al) foil and roll-pressed to form mixture layers each having a density of 3.5 g/cc and a thickness of 160 μm on the foil. This is cut into a width of 57 mm and a length of 600 mm so as to complete positive electrode 2. Positive electrode 2 is provided in a position on its inner side with a 30 mm exposed portion to which an aluminum positive electrode lead is welded. The position of positive electrode 2 does not face negative electrode 1.

### (2) Preparation of Negative Electrode

As silicon-containing particle 35 capable of storing and emitting lithium ions, silicon oxide (SiO_{1.01}) is used. The silicon oxide has an O/Si molar ratio of 1.01 when it is pulverized to a particle diameter of 10 μm or less.

In order to bond the catalytic element to the surface of the silicon oxide particle, a solution in which 1 g of iron nitrate nonahydrate (special grade) is dissolved in 100 g of ion-exchanged water is used. The molar ratio of the silicon oxide particles is measured by gravimetric analysis according to JIS Z2613. The mixture of the silicon oxide particles and the iron nitrate solution is stirred for one hour and dehydrated with an evaporator. As a result, iron nitrate having a particle diameter of 1 nm to 1000 nm is supported in a highly and uniformly dispersed state in the surfaces of the silicon oxide particles.

Next, silicon-containing particles 35 thus supporting the iron nitrate are placed in a ceramic reaction vessel and heated to 500° C. in the presence of helium gas. Then, the helium gas is replaced by a mixture gas consisting of hydrogen gas and carbon monoxide gas in a volume ratio of 50:50 and kept for one hour at 500° C. As a result, the iron nitrate is reduced, and CNFs 36 each having a fiber diameter of about 80 nm and a fiber length of about 50 μm are grown in the form of a plate on the surfaces of the silicon-containing particles.

Then, the mixture gas is again replaced by the helium gas, and the inside of the reaction vessel is cooled to room temperature. The amount of CNFs 36 thus grown is 30 parts by weight per 100 parts by weight of the silicon-containing particles. As a result, composite 34 is prepared.

Next, 100 parts by weight of composite 34 are mixed with 10 parts by weight (solid content) of a 1% aqueous solution of polyacrylic acid having an average molecular weight of 150,000 and 10 parts by weight of core-shell modified styrene-butadiene copolymer as binders. Then, 200 parts by weight of distilled water is added to and dispersed in the mixture so as to prepare a negative electrode mixture paste. The negative electrode mixture paste is applied to both sides of current collector 10 made of 14 μm-thick Cu foil using a doctor blade and dried so as to form mixture layers 12B and 48. Mixture layers 12B and 48 are formed so that dried one has a total thickness (including the Cu foil) of 148 μm. Later, the dried one is roll-pressed to adjust the thicknesses of mixture layers 12B and 48.

The belt-like negative electrode continuous body having current collector 10 with mixture layer 12B on one side and mixture layer 48 on the other side is cut into a width of 59 mm and a length of 750 mm.

Next, mixture layer 12B is provided with 2 mm-wide linear grooves 14C at a spacing of 20 mm in the direction substantially perpendicular to the winding direction in such a manner as to expose current collector 10. Furthermore, current collector 10 is provided at one end thereof with a 5 mm-wide exposed portion to which a nickel (Ni) negative electrode lead is welded.

### (3) Production of Battery

Positive electrode 2 and negative electrode 1 prepared as above are wound with 20 μm-thick polypropylene separator 3B interposed therebetween in such a manner that mixture layer 12B is located at the inner side of winding, thereby forming an electrode assembly. Composite 34 used as the negative electrode active material has a comparatively large irreversible capacity. More specifically, the initial charge and the initial discharge have a capacity difference of about 650 mAh/g. This difference is reconciled as follows.

The electrode assembly thus prepared is soaked in an electrolyte solution in which 1.0 mol/dm³ of LiPF₆ is dissolved in a mixture solvent consisting of ethylene carbonate (EC):dimethyl carbonate (DMC):ethylmethyl carbonate (EMC) in a volume ratio of 2:3:3. After charging is performed at a constant current of 300 mA until the voltage reaches 3.5V, the electrode assembly is disassembled to take negative electrode 1 out.

Negative electrode 1 thus taken out is cleaned with EMC to remove LiPF₆, dried at room temperature, and wound together with another positive electrode 2 so as to form an electrode assembly.

The electrode assembly is placed in a cylindrical battery case (made of iron-nickel plating, 18 mm in diameter, 65 mm in height) which is open at only one side. After disposing an insulating plate between the case and the electrode assembly, the negative electrode lead is welded to the case, and the positive electrode lead is welded to a sealing plate so as to assemble the battery.

After being heated in a vacuum to 60° C. and dried, the battery is filled with 5.8 g of the electrolyte solution in which 1.0 mol/dm³ of LiPF₆ is dissolved in the mixture solvent containing EC:DMC:EMC in a volume ratio of 2:3:3. The battery is sealed by applying the sealing plate to the case.

The battery thus obtained is subjected to three time charge-discharge cycles at a constant current of 300 mA, where charging is terminated at 4.1V, and discharging is terminated at 2.0V so as to produce a non-aqueous electrolyte secondary battery having a theoretical capacity of 3000 mA. This battery is referred to as Example 1.

### Example 2

A battery, which is referred to as Example 2, is prepared in the same manner as Example 1 except that the grooves formed in mixture layer 12B are lattice shaped as shown in FIG. 3A.

### Examples 3 and 4

Batteries, which are referred to as Example 3 and Example 4, respectively, are prepared in the same manner as Example 1 except that the grooves formed in mixture layer 12B have a width of 3 mm and a width of 0.2 mm, respectively.

### Comparative Examples 1 and 2

A battery, which is referred to as Comparative Example 1, is prepared in the same manner as Example 1 except that the negative-electrode mixture layer formed on each side of negative electrode 1 has no groove therein. A battery, which is referred to as Comparative Example 2, is prepared in the same manner as Example 1 except that the grooves have a depth corresponding to the half of the thickness of the mixture layer (one side) so as not to expose current collector 10.

### Example 5

A battery, which is referred to as Example 5, is prepared in the same manner as Example 1 except for the following. First, a paste is prepared by mixing 100 parts by weight of graphite as a negative electrode active material, 3 parts by weight of styrene-butadiene rubber as a binder, and 1 part by weight (solid content) of an aqueous solution of carboxymethylcellulose as a thickener. The paste thus obtained is applied to a Cu foil and roll-pressed in such a manner that the active material (graphite) has a packing density of 1.7 g/cm³ per unit volume of mixture layer 12B and a thickness of 183 μm. Then, this is cut into a width of 59 mm and a length of 698 mm.

### Example 6

A battery, which is referred to as Example 6, is prepared in the same manner as Example 5 except that the packing density of the active material (graphite) per unit volume of mixture layer 12B is 1.6 g/cm³.

### Comparative Example 3

A battery, which is referred to as Comparative Example 3, is prepared in the same manner as Example 5 except that the negative-electrode mixture layer formed on each side of the negative electrode has no groove therein.

### Comparative Example 4

A battery, which is referred to as Comparative Example 4, is prepared in the same manner as Example 6 except that the negative-electrode mixture layer formed on each side of the negative electrode has no groove therein.

The batteries thus produced are evaluated as follows.

### Cycle Characteristics

Examples 1 to 6 and Comparative Examples 1 and 2 are subjected to constant-voltage charging in which charging is performed with a maximum current of 2 A up to 4.2V and then the current value is attenuated while keeping the voltage at 4.2V. Examples 5 and 6 and Comparative Examples 3 and 4 are subjected to constant-voltage charging in which charging is performed with a maximum current of 1 A up to 4.2V and then the current value is attenuated while keeping the voltage at 4.2V. In either case, the charging is performed until the attenuated current reaches 0.3 A. Then, discharging is performed at a constant current of 3 A until the voltage reaches 2V. Charge-discharge operations are repeated under these conditions, and the number of cycles when the discharge capacity falls below 70% of the capacity in the first cycle is used as an index of the cycle characteristics.

### Appearance Check for Electrode Assemblies and Negative Electrodes

After charge-discharge operations are repeated under the same conditions as for the aforementioned evaluation of the cycle characteristics, the batteries are dissembled after 150th cycle so as to check the electrode assemblies for the presence or absence of deformation. The presence and absence of visually recognizable deformation of the electrode assemblies is referred to as “with deformation” and “without deformation”, respectively. The electrode assemblies are also observed from above to check whether the adjacent ones of the blocks formed on the side (inside) of mixture layer 12B having grooves 14C thereon are in contact with each other at their inner side edges. When the adjacent blocks are in contact with each other at their inner side edges, it is referred to as “with contact”. If not, it is referred to as “without contact”.

Furthermore, the electrode assemblies are disassembled, and negative electrodes 1 are rolled out in order to check for the presence or absence of wrinkles in the mixture layers. The negative electrodes having recognizable wrinkles are referred to as “with wrinkles”, those having only small cracks are referred to as “with a few wrinkles”, and those having neither recognizable wrinkles nor small cracks are referred to as “without wrinkles”.

The specifications and evaluation results of Examples 1 to 4 and Comparative Examples 1 and 2 are shown in Table 1.

TABLE 1

| | | | | cycle | deformation | wrinkles |
|---|---|---|---|---|---|---|
| | grooves | | contact | number | of | of |
| | Cu foil | groove | between | at 70% of | electrode | negative |
| | exposure | width (mm) | blocks | capacity | assembly | electrode |
| Example 1 | exposed | 2 | with | 350 | without | without |
| | | | contact | | deformation | wrinkles |
| Example 2 | exposed | 2 | with | 360 | without | without |
| | | | contact | | deformation | wrinkles |
| Example 3 | exposed | 3 | without | 290 | without | without |
| | | | contact | | deformation | wrinkles |
| Example 4 | exposed | 0.2 | with | 320 | without | with a few |
| | | | contact | | deformation | wrinkles |
| Comparative | not | — | — | 150 | with | with |
| Example 1 | exposed | | | | deformation | wrinkles |
| Comparative | not | 2 | without | 220 | with | with |
| Example 2 | exposed | | contact | | deformation | wrinkles |

In Comparative Example 1 having no groove, the electrode assembly exhibits conspicuous deformation. The reason for this seems to be that the lack of the function of absorbing the volume change of the mixture layer due to its expansion and contraction causes the negative electrode to have wrinkles, which are accumulated to cause the deformation of the electrode assembly.

This phenomenon seems to cause the breakdown of the conductive network in the mixture layer, the exfoliation of the mixture layer from current collector 10, and the uneven arrangement of the positive and negative electrodes, thereby deteriorating the cycle characteristics. In Comparative Example 2 having grooves not deep enough to expose current collector 10, the cycle characteristics are better than in Comparative Example 1 having no groove, but still insufficient for practice.

In comparison to these comparative examples, Example 1 having grooves 14C formed in such a manner as to expose current collector 10 exhibits excellent cycle characteristics. The reason for this seems to be that grooves 14C deep enough to reach current collector 10 absorb the volume change of mixture layer 12B due to its expansion and contraction, thereby preventing the deformation of negative electrode 1 and the electrode assembly.

The excellent cycle characteristics may also be achieved as a result that the adjacent ones of the blocks of mixture layer 12B that are in contact with each other at their inner side edges prevent lithium from depositing on the exposed portion of current collector 10.

Example 2 having grooves 14C of lattice shape has slightly higher cycle characteristics than Example 1 probably because negative electrode 1 has a higher function of absorbing the volume change of mixture layer 12B than negative electrode 1 of Example 1.

Example 3 having grooves 14C with an increased width has slightly lower cycle characteristics than Example 1. The reason for this seems to be that the adjacent ones of the blocks of mixture layer 12B are not fully in contact with each other at their edges when the electrode assembly is wound and that there is some deposition of lithium on current collector 10 due to the large charging current.

Example 4 having grooves 14C with a reduced width has lower cycle characteristics than Example 1. The reason forth is seems to be that the grooves cannot fully absorb the volume change of mixture layer 12B although the adjacent ones of the blocks of mixture layer 12B are in contact with each other at their edges on the inner side of the winding.

Next, the specifications and evaluation results of Examples 5 and 6 and Comparative Examples 3 and 4 are shown in Table 2.

TABLE 2

| | | | | cycle | deformation | wrinkles |
|---|---|---|---|---|---|---|
| | grooves | | packing | number | of | of |
| | Cu foil | groove | density | at 70% of | electrode | negative |
| | exposure | width (mm) | g/cm³ | capacity | assembly | electrode |
| Example 5 | exposed | 2 | 1.7 | 360 | without | without |
| | | | | | deformation | wrinkles |
| Example 6 | exposed | 2 | 1.6 | 380 | without | without |
| | | | | | deformation | wrinkles |
| Comparative | not | — | 1.7 | 300 | without | without |
| Example 3 | exposed | | | | deformation | wrinkles |
| Comparative | not | — | 1.6 | 370 | without | without |
| Example4 | exposed | | | | deformation | wrinkles |

In Example 5 and Comparative Example 3, the packing density of graphite, which is used as the active material, is as high as 1.7 g/cm³. In Comparative Example 3 having no groove in the negative-electrode mixture layer, no deformation is observed in the electrode assembly, but it takes only about 300 cycles until the capacity becomes 70%. In comparison, Example 5 having grooves 14C in mixture layer 12B exhibits excellent cycle characteristics. The reason for this seems to be that the grooves 14C work to prevent the exhaustion of the electrolyte solution, which is a cause of the deterioration of the cycle characteristics.

In Example 6 and Comparative Example 4, the packing density of graphite, which is used as the active material, is 1.6 g/cm³. Example 6 having grooves 14C in mixture layer 12B exhibits nearly the same cycle characteristics as Comparative Example 4 having no groove in the negative-electrode mixture layer. This indicates that in the case of using graphite as the active material, providing grooves has remarkable effect when the packing density of the active material is 1.7 g/cm³ or more.

### Third Exemplary Embodiment

In the first and second exemplary embodiments, the cases are described where the current collector is applied thereon with a negative-electrode mixture layer including a binder and an active material capable of storing and emitting lithium ions. In contrast, the present embodiment describes a case where the current collector has the negative-electrode mixture layer formed thereon by directly depositing an active material. The following is a description of a negative electrode using as a negative electrode active material columnar silicon oxide having a composition range expressed by SiOₓ where 0.05≦x≦1.95.

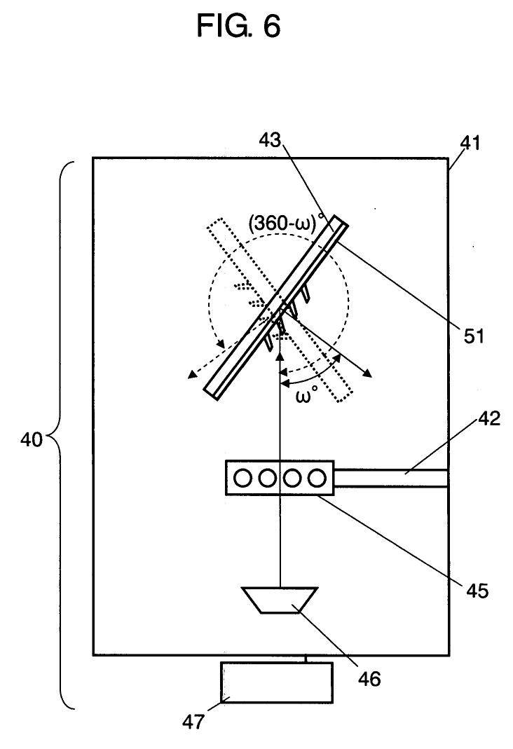

FIG. 6 is a schematic view of manufacturing equipment for forming columnar silicon oxide as a negative electrode active material on a current collector. Manufacturing equipment 40 includes deposition unit 46 for forming a columnar body by depositing a deposition material on the surface of current collector 51, gas inlet pipe 42 for introducing oxygen gas into a vacuum chamber, and fixing base 43 for fixing current collector 51. These units are placed in vacuum chamber 41. Vacuum pump 47 depressurizes vacuum chamber 41. Gas inlet pipe 42 is provided at its tip with nozzle 45 for discharging oxygen gas into vacuum chamber 41. Fixing base 43 is set above nozzle 45. Deposition unit 46 is set vertically below fixing base 43. Deposition unit 46 includes an electron beam as a heater, and a crucible to contain the deposition materials. In manufacturing equipment 40, the positional relationship between current collector 51 and deposition unit 46 can be changed by the angle of fixing base 43.

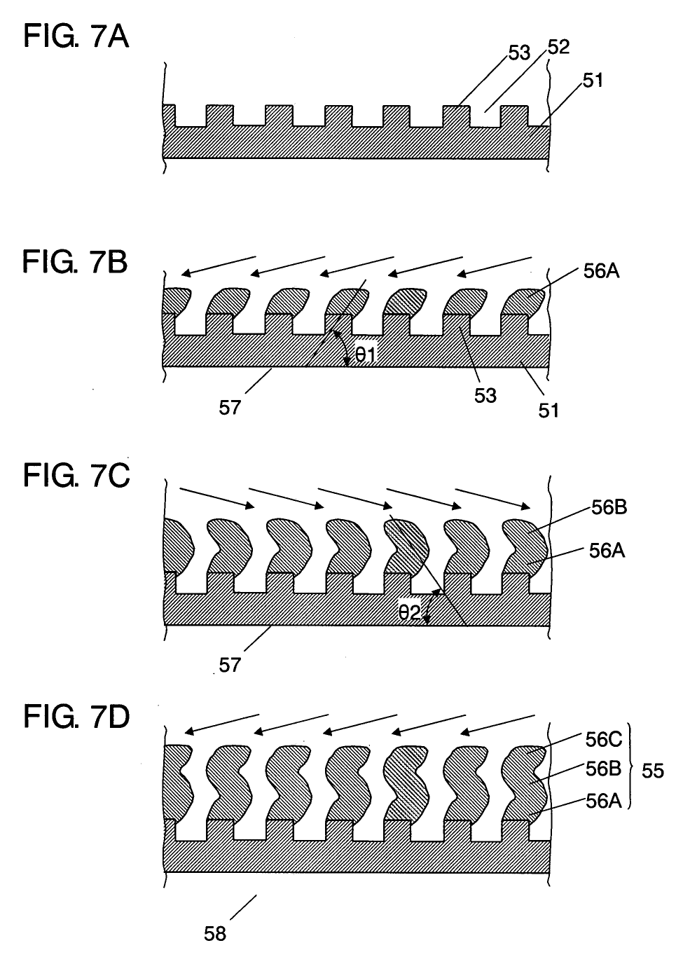

The procedure to form the columnar silicon oxide on current collector 51 is described with reference to the schematic sectional views of FIGS. 7A to 7D. First, as shown in FIG. 7A, current collector 51 is prepared by plating a base material so as to form depressions 52 and projections 53 on its surface in such a manner that projections 53 are at a spacing of, for example, 20 μm. The base material is made of metal foil such as copper and nickel. Then, current collector 51 is fixed to fixing base 43 shown in FIG. 6.

Next, as shown in FIG. 6, fixing base 43 is set in such a manner that the normal direction of current collector 51 is at an angle of ω° (55°, for example) with respect to the incident direction from deposition unit 46. Then, for example, Si (scrap silicon: 99.999% purity) is heated with the electron beam and evaporated so as to be fallen on projections 53 of current collector 51. More specifically, Si is emitted in the direction of the arrow shown in FIG. 7B. At the same time, oxygen (O₂) gas is introduced through gas inlet pipe 42 and supplied to current collector 51 through nozzle 45. Vacuum chamber 41 is in an oxygen atmosphere of a pressure of, for example, 3.5 Pa. As a result, SiOₓ obtained by the bond of Si and oxygen is deposited on projections 53 of current collector 51 so as to form first-stage columnar portions 56A having a predetermined height (thickness). Columnar portions 56A are formed at an angle of θ1 with respect to plane 57 of current collector 51 where projections 53 are not formed thereon.

Next, fixing base 43 is turned so that the normal direction of current collector 51 is at an angle of (360-ω)° (305°, for example) with respect to the incident direction from deposition unit 46 as shown in the broken line in FIG. 6. Then, Si is evaporated from deposition unit 46 and emitted in the direction of the arrow shown in FIG. 7C so as to be fallen on first-stage columnar portions 56A on current collector 51. At the same time, O₂ gas is introduced through gas inlet pipe 42 and supplied to current collector 51 through nozzle 45. As a result, SiOₓ is deposited to form second-stage columnar portions 56B on first-stage columnar portions 56A. Second-stage columnar portions 56B are formed at a predetermined height (thickness) and an angle of θ2 with respect to plane 57.

Next, fixing base 43 is returned to the state shown in FIG. 7B, and third-stage columnar portions 56C are formed at a predetermined height (thickness) on columnar portions 56B. As a result, columnar portions 56B and columnar portions 56C are deposited at different angles and directions from each other. Columnar portions 56A and columnar portions 56C are deposited in the same direction. As a result, columnar bodies 55 each consisting of three-stage columnar portions are formed on current collector 51.

Negative electrode 58 prepared by forming columnar bodies 55 on current collector 51 can be used in place of negative electrode 1 shown in FIG. 1. If the collection of columnar bodies 55 is regarded as a negative-electrode mixture layer, the gaps between columnar bodies 55 can be regarded as a plurality of mixture-layer expansion-absorbing grooves formed in such a manner as to expose current collector 51 in the position facing positive-electrode mixture layer 8.

The aforementioned description shows the example of columnar bodies 55 consisting of three-stage columnar portions, but the number of columnar portions is not limited to three stages. For example, the processes shown in FIGS. 7B and 7C can be repeated to form columnar bodies having arbitrary n-stage (n≧2) columnar portions. The directions in which the columnar bodies in each of the n stages are deposited can be controlled by changing the angle ω by turning fixing base 43. The angle ω is formed between the normal direction of the surface of current collector 51 and the incident direction from deposition unit 46.

The following is a description of a specific example of the present embodiment. In the present example, a model cell of the same coin shaped type as shown in FIG. 1 is produced and evaluated. The model cell is different from the battery shown in FIG. 1 in that metallic lithium is used as a counter electrode in place of positive electrode 2 for the purpose of clarifying the effect of the mixture-layer expansion-absorbing grooves in negative electrode 58.

### Example 7

Current collector 51 is prepared by forming projections 53 at a spacing of 20 μm by plating on a belt-like 30 μm-thick electrolytic copper foil used as a base material. According to the aforementioned procedure, the angle of fixing base 43 is adjusted to set the angle ω° at 60°, and columnar portions 56A having a height of 10 μm and a section area of 300 μm² is formed at a deposition rate of about 8 nm/s. Then, columnar portions 56B and 56C are formed by adjusting the angle of fixing base 43. In this manner, three-stage columnar bodies 55 having a total height of 30 μm and a section area of 300 μm² are formed on current collector 51. Current collector 51 is punched out into a circle of 12.5 mm in diameter so as to form negative electrode 58. Then, 15 μm-thick metallic lithium is evaporated on the surface of negative electrode 58 by vacuum deposition.

The angles θ1 and θ2 of columnar portions 56A, 56B, and 56C with respect to plane 57 of current collector 51 are evaluated by cross-sectional observation with a scanning electron microscope. As a result, it turns out that the columnar portions in each stage are deposited at an angle of about 41°.

Negative electrode 58 thus formed is put in case 6 having a diameter of 20 mm and a thickness of 1.6 mm. Lithium metal is placed thereon via 20 μm-thick separator 3B. A few drops of electrolyte solution 3A are poured, and case 6 is sealed to complete a model cell having a theoretical capacity of about 8.8 mAh. The electrolyte solution is prepared by dissolving 1.0 mol/dm³ of LiPF₆ in a mixture solvent containing EC:DMC:EMC in a volume ratio of 2:3:3.

### Comparative Example 5

A model cell is produced as Comparative Example 5 in the same manner as in Example 7 except that the negative electrode is prepared by depositing SiOₓ flat on the current collector with no projections 53 thereon. More specifically, SiOₓ is deposited in the same manner as in Example 7 except that a belt-like 30 μm-thick electrolytic copper foil is used as the current collector and that fixing base 43 is set so that the normal direction of current collector 51 is 180° with respect to the incident direction from deposition unit 46 in FIG. 6.

### Evaluation of Model Cells

The model cells thus produced are discharged at a constant current of 0.44 mA until the voltage reaches 0V, and then charged at a constant current of 0.44 mA until the voltage reaches 1V. As a charge-discharge cycle test, these operations are repeated until the charging capacity falls below 70% of the charging capacity in the first cycle. After the charge-discharge cycle test, the model cell is decomposed to observe the condition of the negative electrode. The evaluation results are shown in Table 3.

In the present embodiment, the model cell is formed by combining metallic lithium with negative electrode 58 having a nobler potential than metallic lithium. As a result, lithium ions are released during charging and stored during discharging by negative electrode 58, as opposed to normal batteries.

TABLE 3

| | | |
|---|---|---|
| grooves | cycle | wrinkles |

| | | groove | number | of |
|---|---|---|---|---|
| | Cu foil | width | at 70% of | negative |
| | exposure | (mm) | capacity | electrode |
| Example 7 | exposed | 0.02 | 410 | without |
| | | | | wrinkles |
| Comparative | not | — | 270 | with |
| Example 5 | exposed | | | wrinkles |

As apparent from Table 3, the model cell of Example 7 has much higher charge-discharge cycle characteristics than Comparative Example 5. Furthermore, no wrinkle has been observed in negative electrode 58 after the test. This indicates that even if the mixture-layer expansion-absorbing grooves have a width of 20 μm, charge-discharge cycle characteristics can be excellent when columnar bodies 55 corresponding to the blocks of the mixture layer have a section area of 300 μm².

On the other hand, the negative electrode of Comparative Example 5 has shown a lot of wrinkles after the test. The reason for this seems to be that the active material of the negative electrode is densely formed with no material such as CNFs to absorb its expansion, and that the absence of the mixture-layer expansion-absorbing grooves increases the influence of the expansion of the active material.

### INDUSTRIAL APPLICABILITY

The non-aqueous electrolyte secondary battery of the present invention can contribute to an improvement in lifetime characteristics and energy density of lithium batteries which are expected to be in great demand further in the future because of their high capacity, high rate characteristics, and greatly improved charge-discharge cycle characteristics.

1. A non-aqueous electrolyte secondary battery comprising:
a positive electrode including a positive-electrode mixture layer;
a negative electrode including:
a current collector; and
a first negative-electrode mixture layer and a second negative-electrode mixture layer provided on opposite surfaces of the current collector respectively, each of the negative-electrode mixture layers containing an active material capable of storing and emitting lithium ions, and
a non-aqueous electrolyte placed between the positive electrode and the negative electrode;
wherein the positive electrode and the negative electrode are wound together in such manner that the first negative-electrode mixture layer is on an inner side of the current collector,
the first negative-electrode mixture layer is provided with a plurality of mixture-layer expansion-absorbing grooves formed in such a manner as to expose the current collector, the plurality of mixture-layer expansion-absorbing grooves are formed in a position facing the positive-electrode mixture layer,
and
top surface edges of the first negative-electrode mixture layer adjacent via one of the mixture layer expansion-absorbing grooves are in contact with each other.

2. The non-aqueous electrolyte secondary battery according to claim 1, wherein the first negative-electrode mixture layer is divided into a plurality of independent blocks by the mixture-layer expansion-absorbing grooves.

3. (canceled)

4. The non-aqueous electrolyte secondary battery according to claim 1, wherein the mixture-layer expansion-absorbing grooves are substantially perpendicular to a direction of winding the negative electrode.

5. (canceled)

6. The non-aqueous electrolyte secondary battery according to claim 1, wherein the active material has a ratio of a volume in a charged state to a volume in a discharged state of at least 1.2.

7. The non-aqueous electrolyte secondary battery according to claim 6, wherein each of the negative-electrode mixture layers further includes:
a carbon nanofiber attached to a surface of the active material; and
at least one catalytic element promoting growth of the carbon nanofiber, the catalytic element being selected from a group consisting of Cu, Fe, Co, Ni, Mo, and Mn, and
the active material, the carbon nanofiber, and the catalytic element form a composite negative electrode active material.

8. The non-aqueous electrolyte secondary battery according to claim 1, wherein the active material is a silicon-containing material.

9. The non-aqueous electrolyte secondary battery according to claim 8, wherein the silicon-containing material is silicon oxide expressed by SiOₓ where 0.05≦x≦1.95.
